(19) United States
(12) Patent Application Publication
(10) Pub. No.: US 2022/0413950 A1
(43) Pub. Date: Dec. 29, 2022

(54) Automated Media Maintenance

(71) Applicant: SOFTIRON LIMITED, Chilworth (GB)

(72) Inventor: Alan Ott, Oviedo, FL (US)

(73) Assignee: SOFTIRON LIMITED, Chilworth (GB)

(21) Appl. No.: 17/844,991

(22) Filed: Jun. 21, 2022

Related U.S. Application Data
(60) Provisional application No. 63/214,404, filed on Jun. 24, 2021.

(51) Int. Cl. G06F 11/00; G06F 11/26

(52) U.S. Cl. CPC G06F 11/004; G06F 11/26

(57) ABSTRACT

An apparatus includes a processor interface circuit to a motherboard processor, an out of band (OOB) interface circuit to connect the apparatus to a media tray, and circuitry configured to determine a preliminary indication that a candidate storage device of the media tray will fail, cause isolation of the candidate storage device from the motherboard processor based upon the determination of the preliminary indication, and run a secondary diagnostic test on the candidate storage device through the OOB interface after isolating the candidate storage device.

### PRIORITY

This application claims priority to U.S. Provisional Patent Application No. 63/214,404 filed Jun. 24, 2021, the contents of which are hereby incorporated in their entirety.

### FIELD OF THE INVENTION

The present disclosure relates to electronic data storage and, more particularly, to automated media maintenance.

### BACKGROUND

Software-Defined Storage (SDS) may be designed to accommodate single point failures. One such failure is a media storage device. However, inventors of embodiments of the present disclosure have discovered embodiments that utilize predictive techniques to avoid a complete failure of a device. Embodiments of the present disclosure may include predictive techniques that can be used to identify storage devices that may be about to fail, which may be referred to as a pre-pre-failure state. However, inventors of embodiments of the present disclosure have discovered that it may be a challenge on how to use this information to address a potentially failing storage media device. While an SDS implementation can be instructed to take a given device out of active operation so that it can be physically replaced, this may take some time. Furthermore, inventors of embodiments of the present disclosure have discovered that predictive applications can have false positives, wherein devices are identified as about to fail but are not, in fact, about to fail. Even though the device may not be liable to imminent failure, it might still be discarded after replacement. This may cause an unnecessary waste of resources.

One method is to test the device while it is connected to an SDS server. To be certain that the device is still usable, thorough testing may be used. However, inventors of embodiments of the present disclosure have discovered that this can consume an appreciable portion of the production resources.

Inventors of embodiments of the present disclosure have discovered embodiments to address one or more of these discoveries.

### SUMMARY

Embodiments of the present disclosure may include an apparatus. The apparatus may include a processor interface circuit to a motherboard processor, an out of band (OOB) interface circuit to connect the apparatus to a media tray, and circuitry configured to determine a preliminary indication that a candidate storage device of the media tray will fail, cause isolation of the candidate storage device from the motherboard processor based upon the determination of the preliminary indication, and run a secondary diagnostic test on the candidate storage device through the OOB interface after isolating the candidate storage device.

### BRIEF DESCRIPTION OF THE DRAWINGS

FIGS. 1A and 1B are illustrations of system architecture of a system with an SDS for automated media maintenance, according to embodiments of the present disclosure.

FIGS. 2A and 2B are illustrations of production and out-of-band pathways in the system architecture, according to embodiments of the present disclosure.

FIG. 3 is a more detailed illustration of components of the system architecture for selecting between production and out-of-band pathways, according to embodiments of the present disclosure.

FIG. 4 is an illustration of an intelligent storage media tray, according to embodiments of the present disclosure.

FIG. 5 is an illustration of an example method for isolation of a potentially failing storage media device, according to embodiments of the present disclosure.

FIG. 6 is an illustration of an example method for self-testing of a potentially failing storage media device, according to embodiments of the present disclosure.

FIG. 7 is an illustration of an example method for stress testing of a potentially failing storage media device, according to embodiments of the present disclosure.

### DETAILED DESCRIPTION

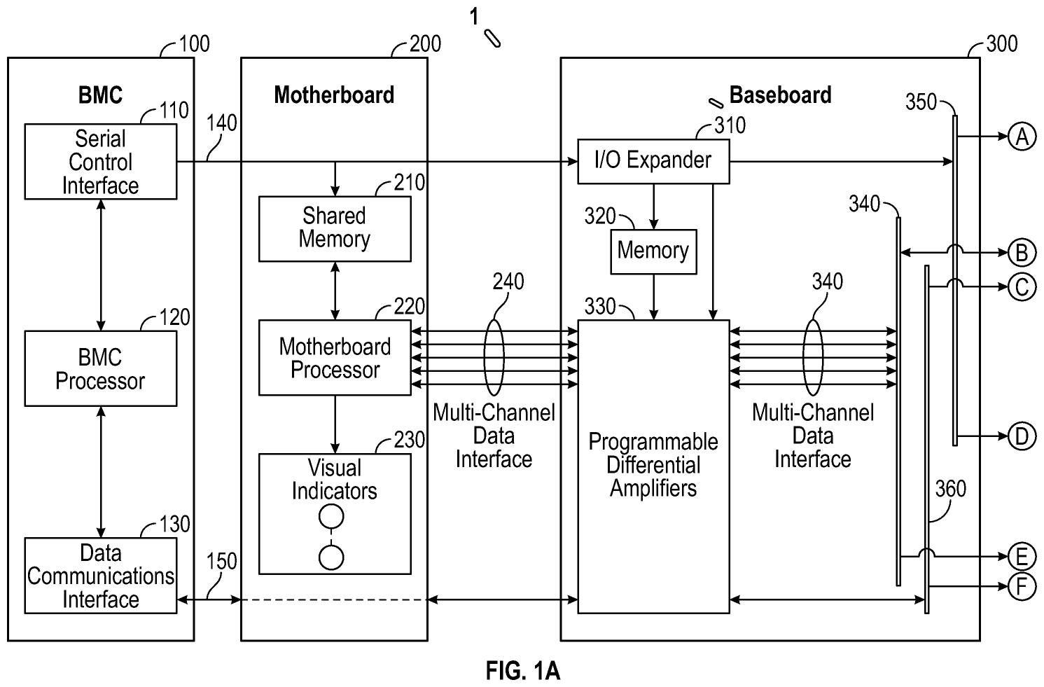

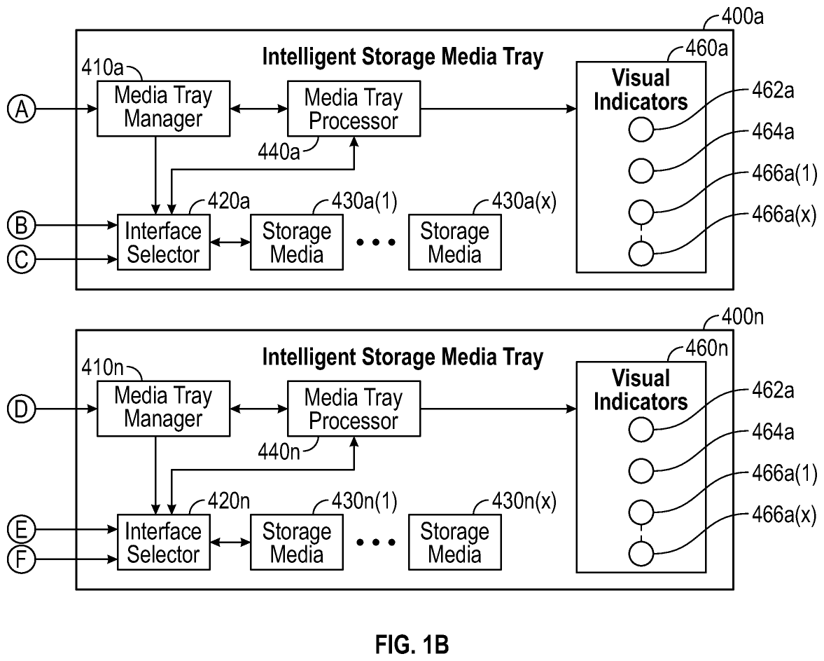

FIGS. 1A and 1B are illustrations of system architecture of a system 1 with an SDS for automated media maintenance, according to embodiments of the present disclosure. Although system 1 is illustrated with particular components, any suitable architecture and components may be used. System 1 may include a baseboard management controller (BMC) 100, motherboard 200, baseboard 300, and any suitable number of intelligent storage media trays 400.

BMC 100 may be implemented in any suitable manner. BMC 100 may include a BMC processor 120. Processor 120 may be implemented by any suitable processor. BMC 100 may be a complete, self-contained system with system 1 or a server therein with its own operating environment and memory. BMC 100 may provide typical BMC functions, such as motherboard management. Moreover, BMC 100 may be configured to provide control and data interfaces to motherboard 200, baseboard 300, and trays 400.

BMC 100 may include a serial control interface 110 and a data communications interface 130. Interfaces 110, 130 may be implemented in any suitable manner, such as by analog circuitry, digital circuitry, control logic, instructions for execution by a processor, digital logic circuits programmed through hardware description language, application specific integrated circuits (ASIC), field programmable gate arrays (FPGA), programmable logic devices (PLD), or any suitable combination thereof, whether in a unitary device or spread over several devices. Serial control interface 110 may be configured to provide a serial communications channel 140 to interact with motherboard 200, baseboard 300, and trays 400 to send instructions or receive control information. Data communications interface 130 may be configured to provide a data communications channel 150 to storage media devices 430 of trays 400.

Although described as a “serial communications channel”, serial communications channel 140 may be implemented by any out-of-band (OOB) communications channel or protocol. Channel 140 may be OOB with respect to the chain of communication between a motherboard processor 220 and storage media devices 430 in trays 400. Moreover, data communications channel 150 may be another OOB communications channel or protocol with respect to communication between a motherboard processor 220 and storage media devices 430.

Motherboard 200 may include a motherboard processor 220, shared memory 210 and visual indicators 230. Processor 220 may be implemented by any suitable processor. Shared memory 210 may be implemented by any suitable implementation of memory and may be accessible to both motherboard 200 and BMC 100 through channel 140. In the production domain of the server during normal use of SDS, motherboard processor 220 may be configured to provide a multi-channel data interface 240 to storage media devices 430 in trays 400. Data interface 240 may include any suitable number of channels or connections in any suitable format or protocol. Motherboard 200 may also include pass-throughs for channels 140, 150 to baseboard 300. Motherboard 200 may include a set of visual indicators 230. These may be visible externally on server 1. In one embodiment, indicators 230 may be implemented by an LCD display capable of displaying error codes.

BMC 100 may be configured to communicate with motherboard processor 220 of using the serial communications channel 140 and shared memory 210.

Baseboard 300 may include any suitable portion of server. Baseboard 300 may include any suitable number and kind of programmable differential amplifiers 330. Programmable differential amplifiers 330 may be programmed by motherboard processor 220 through interface 240. Programmable differential amplifiers 330 may be configured to route the data communications interfaces from BMC 100 and motherboard 200. Interface 240 from motherboard 200 may be routed to a production data interface 340 that is connected to trays 400. BMC 100 data communications interface 150 can connect via motherboard 200 in pass-through manner between BMC 100 and programmable differential amplifiers 330. A secondary data bus 360 may be connected between programmable differential amplifiers 330 and trays 400. Programmable differential amplifiers 330 may be configured to selectively enable or disable these connections, and thus select between application of interface 340 or interface 360 to trays 400. Using serial communications channel 140, BMC processor 120 can issue control signals that determine how connections are enabled or disabled. These may be routed through an I/O expander 310. A memory 320 on baseboard 300 may be used to store default connection values. The control signals may be passed to programmable differential amplifiers 330. Moreover, I/O expander 310 may route serial communications channel 140 to a serial control interface 350 to connect to trays 400.

Trays 400 may include storage media devices 430. Each tray 400 may include any suitable number and kind of storage media devices 430. Each tray 400 may include a different number or a different kind of storage media device 430. Storage media devices 430 may be implemented in any suitable manner, such as by hard disks or SSDs. Each tray 400 may include a media tray processor 440 implemented by any suitable processor. Each tray 400 may include a media tray manager 410 configured to control the functions of the respective tray 400. Media tray manager 410 may be implemented in any suitable manner, such as by analog circuitry, digital circuitry, control logic, instructions for execution by a processor such as processor 440, digital logic circuits programmed through hardware description language, ASICs, FGPAs, PLDs, or any suitable combination thereof, whether in a unitary device or spread over several devices. Media tray manager 410 may be configured to receive instructions from BMC 100 using serial control interface 140 and 350. The instructions may be to select which data connectivity to use to connect to storage media devices 430. For example, the selection of connections may be from production data interface 340, the secondary data interface 360, or media tray processor 440. The selective application of these interfaces may be to provide OOB connectivity that may facilitate testing of storage media devices 430 without interfering with typical SDS operations through production data interface 340. Media tray manager 410 may also be used to control a set of visual indicators 460, which may indicate various status conditions as discussed further below.

Trays 400 may include an interface selector 420. Interface selector 420 may be implemented in any suitable manner, such as by analog circuitry, digital circuitry, control logic, instructions for execution by a processor such as processor 440, digital logic circuits programmed through hardware description language, ASICs, FGPAs, PLDs, or any suitable combination thereof, whether in a unitary device or spread over several devices. Interface selector 420 may be controlled by media tray manager 410 or media tray processor 420 to select which of interfaces 340, 360 to receive data from. Interface selector 420 may include input channels to select, for each of storage media devices 430, an input from data interface 340 or data interface 360.

The implementation of multi-channel data interface 240 may depend on the type or version of motherboard 200, baseboard 300, and trays 400 and media storage devices 420 connected thereto. Programmable differential amplifiers 330 may then provide multi-channel data interfaces 340 to data channels of trays 400 and media storage devices 420 connected thereto. Programmable differential amplifiers 240 may be programmed to specifically match the requirements using signal gain and conditioning for the individual signals to or from motherboard 200 and trays 400 and media storage devices 420. The adjustment of the signal gain and conditioning can be used in conjunction with predicted or measured transmission errors, to determine an optimal operating level. The settings can also be stored in memory. This provides a mechanism, for example, to configure the individual signal amplification levels and signal conditioning at the time of manufacture, and to later fine-tune them as needed.

Data may be routed in the SDS production environment between motherboard processor 220 and programmable differential amplifiers 330 over multi-channel data interface 240. Moreover, such data may be routed between programmable differential amplifiers 330 and storage media devices 430 over multi-channel data interface 340.

Data may be routed OOB from the SDS production environment between BMC 100 and programmable differential amplifiers 330 over data interfaces 130, 150. Moreover, such data may be routed between programmable differential amplifiers 330 and storage media devices 430 over data interface 360.

Interfaces 130, 150, 240, 340, 360 may be implemented in any suitable manner, such as by data channels, traces, cabling, and using any suitable protocol. In various embodiments, interfaces 130, 150, 360 may have less bandwidth or connections that interfaces 240, 340, as OOB stress testing may utilize greater resources and power than production SDS usage in interfaces 240, 340. Interfaces 130, 150, 360 may, for example, support a single channel.

For a given storage media device 430, based upon a selection of interface selector 420, one of interfaces 340, 360 may be connected to the given storage media device 430.

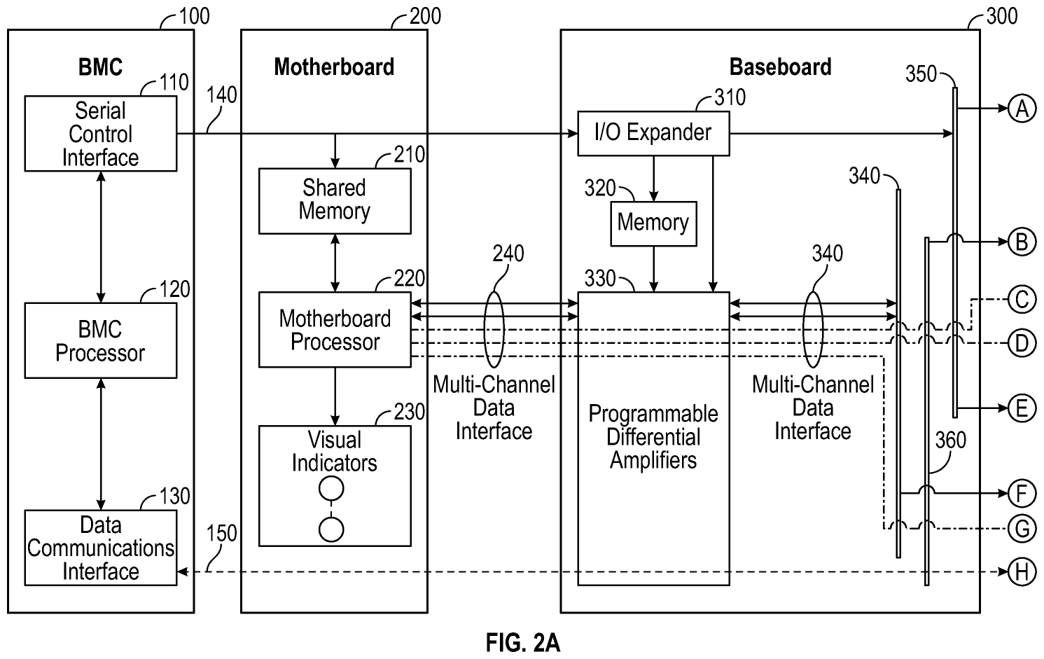

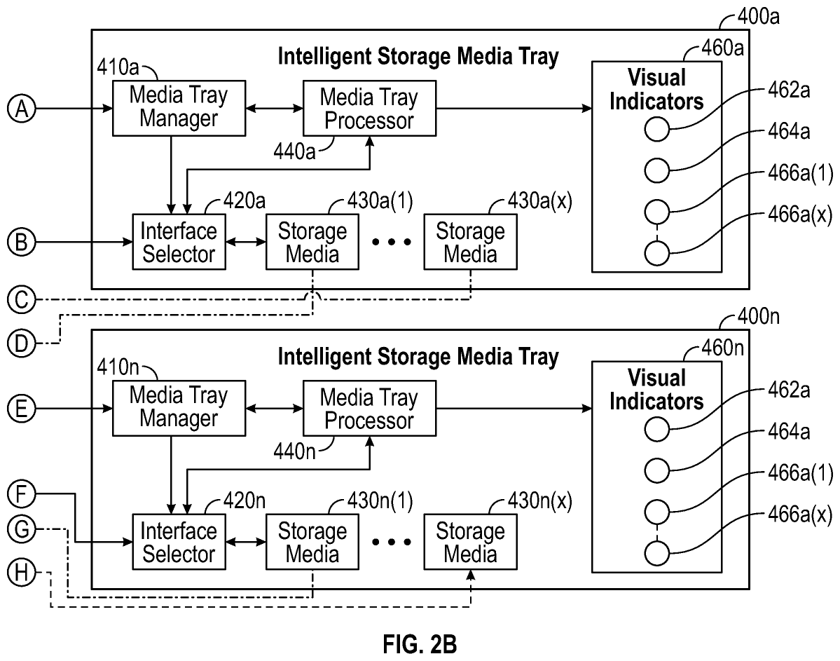

FIGS. 2A and 2B are illustrations of production and OOB pathways in the system architecture, according to embodiments of the present disclosure. Overlain on the contents of FIG. 1 are an OOB pathway between BMC 100 and a given storage media device 430, shown as an example in FIG. 1 over data communications interface 130, interface 150 passed through motherboard 200, into programmable differential amplifiers 330, over interface 360, selected through interface selector 420N in tray 400N, to storage media device 430N(X). Also overlain on the contents of FIG. 1 are production pathways between motherboard 200 and motherboard processor 220 therein, over interface 240, into programmable differential amplifiers 330, over interface 340, selected through various interface selectors 420 in trays 400, to various storage media devices 430. In the present disclosure and as an example, multiple channels or connections may be connecting motherboard processor 220 and storage media devices 430 for production pathways, while a single channel or connection may be connecting BMC 100 and a storage media device 430 for an OOB pathway.

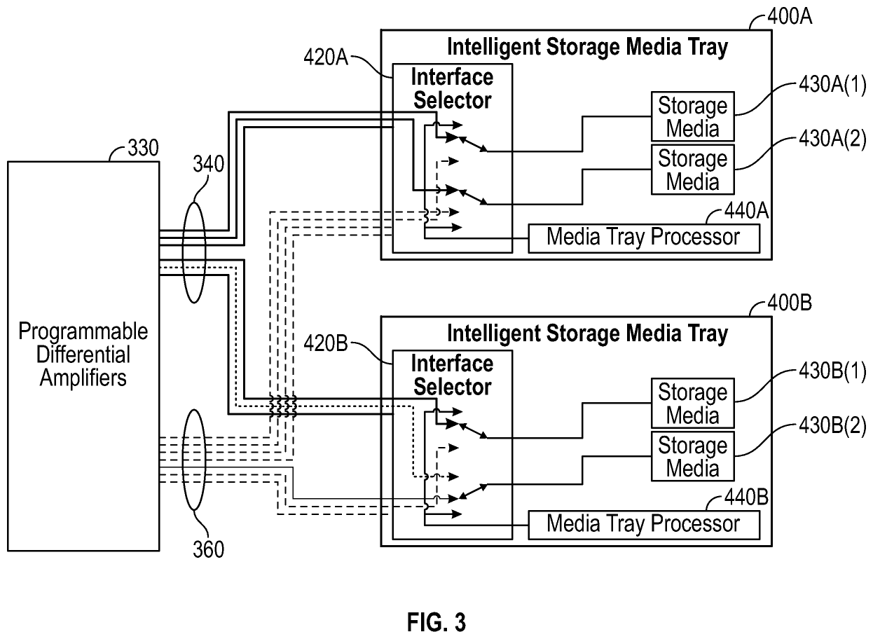

FIG. 3 is a more detailed illustration of components of the system architecture for selecting between production pathways, OOB pathways, and access by media tray processor 440, according to embodiments of the present disclosure. Shown in FIG. 3 are the portions of the pathways between programmable differential amplifiers 330 and storage media devices 430. Moreover, more detailed illustrations of interface selectors 420 are shown. In addition, possible routing between storage media devices 430 and media tray processor 440 are shown.

Solid lines in FIG. 3 may illustrate example active connections or channels, while dashed lines in FIG. 3 may illustrate possible but inactive connections or channels. In the example of FIG. 3, a single OOB connection is active to storage media device 430B(2) while production connections are active to the other storage media devices 430A(1), 430A(2), and 430B(1). Interface 340 may provide possible connections from programmable differential amplifiers 330 (and, by extension, motherboard processor 220) to each of storage media devices 430. Interface 360 may provide possible connections from programmable differential amplifiers 330 (and, by extension, BMC 100) to each of storage media devices 430.

In one embodiment, for a given storage media device 430, only one of the production pathways from interface 340 or the OOB pathway 360 may be selected at a time to be routed to the given storage media device 430. In one embodiment, connections selected to be routed to a given storage media device 430 may be made by respective media tray managers 410 under instruction by BMC processor 120 over serial control interface 110, interface 140, I/O expander 310, and interface 350. In another embodiment, programmable differential amplifiers 330 may be configured to enable or disable signals over selected pathways based upon control signals from BMC processor 120 that may be provided by, for example, shared memory 320. In various embodiments, both programmable differential amplifiers 330 and media tray manager 410 may be configured to select signals for connection over selected pathways to storage media devices 430.

Furthermore, for a given storage media device 430, a connection to the media tray processor 440 of the tray 400 on which the given storage media device 430 resides may be selectable by interface selector 420. This connection may be to various software or other configurations of media tray processor 440, such as media tray manager 410.

Interface selector 420 may include a switch for each respective storage media device 430 of tray 400. The switch may be configured to select between the production pathway from interface 340, the OOB pathway from interface 360, and media tray processor 440 to route to the given storage media device 430. Although not shown, the switch may also be able to select none of these choices.

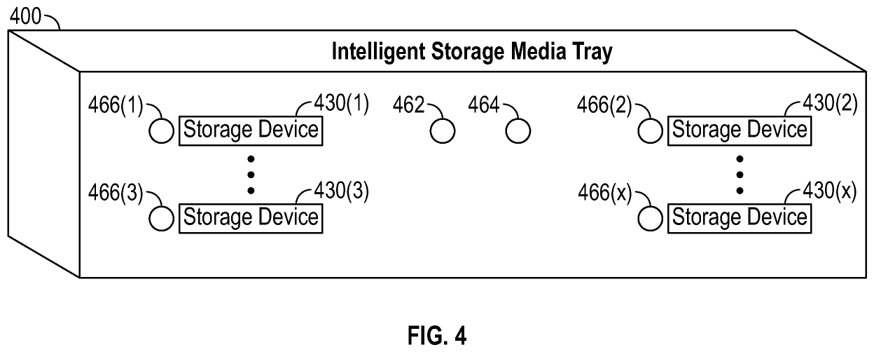

FIG. 4 is an illustration of an intelligent storage media tray 400, according to embodiments of the present disclosure. In one embodiment, media tray manager 410 may activate a first visual indicator 462 on tray 400 to indicate a change in status has occurred. In one embodiment, first indicator 462 may be in the form of a red, blue, or yellow light. Media tray manager 410 may activate a second visual indicator 464, in the form of a green light, indicating that it is safe for a user to proceed with decoupling tray 400 that is housing a failed storage media device 430. The indicators may be implemented in any suitable manner, such as using LEDs, light pipes, or other forms of light generating hardware as desired. Other embodiments may have a single indicator such as first visual indicator 462 implemented as an LED that changes colors. The indicators may indicate, for example, that the tray includes available media devices, or that it is not safe to decouple and remove tray because devices are active or being tested, or that given drive or any drive is bad, or that the tray can be removed.

Tray 400 may include slots or caddies to house storage media devices 430. Tray 400 may include any suitable number or kind of storage media devices 430, although four such storage media devices 430 are shown. Each storage media device 430 may be associated with a corresponding internal visual indicator 466. In various embodiments, storage media devices 430 may be of a same or a different type with respect to other storage media devices 430 of a same tray 400 or of different trays 400. Storage media devices 430 may be coupled to tray 400 via any suitable bay, caddy, or hardware interface. Storage media devices 430 may be implemented by magnetic storage devices such as hard disks, and solid-state media such as flash disks, although other types of storage media not explicitly mentioned herein are also contemplated.

Indicators 466 may be situated in specific physical proximity to corresponding storage media devices 430. Each of indicators 466 may be activated when a corresponding storage media device 430 has a changed status. Thus, a specific storage media device 430, with changed status, can be identified by noting the activated internal visual indicator 466 to which the specific storage media device 430 corresponds. In some embodiments, internal indicators 466 may be embedded in a casing of or otherwise coupled to tray 400 that is, for example, proximate to the mounting screw or similar hardware of storage media device 430, such as may be used proximate to or configured as part of the bay or coupling mechanism of storage media device 430, such that each storage media device 430 housed in tray 400 has a corresponding visual indicator uniquely identifying it based on physical proximity. This may assist a user, such as a technician, as to which storage media device 430 corresponds to which internal visual indicator 466.

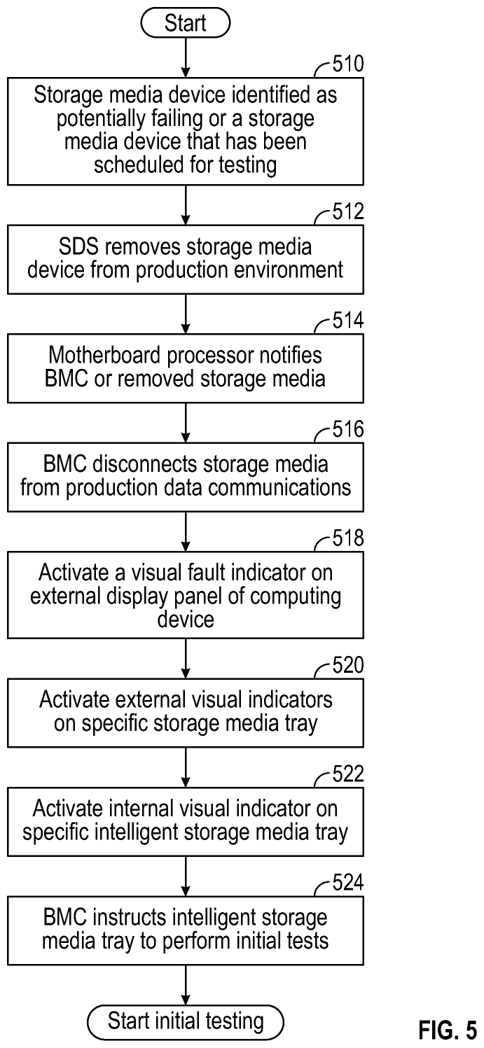

FIGS. 5-7 illustrate example methods and possible portions of an overall method for testing storage media devices 430 while a given storage media device 430 is still installed in a server and as part of an SDS system. The methods may address prediction of storage media device potential failure without impacting the overall performance of the SDS system. The methods may be performed to prevent false positives from wasting resources by removing and disposing of drives that are in fact able to pass quality tests. The methods of FIGS. 5-7 may be performed by any suitable mechanism, such as by any of the elements of FIGS. 1-4. In particular, the methods of FIGS. 5-7 may be performed by a control circuit. The control circuit may be implemented by instructions in a medium for execution by a processor, a function, library call, subroutine, shared library, software as a service, analog circuitry, digital circuitry, control logic, digital logic circuits programmed through hardware description language, ASIC, FPGA, PLD, or any suitable combination thereof, or any other suitable mechanism, whether in a unitary device or spread over several devices. The control circuit may be implemented by, for example, BMC processor 120, media tray manager 410, media tray processor 440, or interface selector 420. The methods may begin at any suitable step. The steps of the methods may be performed in any suitable order, repeated, rearranged, performed recursively, omitted, or performed in parallel. The methods themselves may be performed in any such suitable order, repeated, rearranged, performed recursively, omitted, or performed in parallel.

FIG. 5 is an illustration of an example method for isolation of a potentially failing storage media device, according to embodiments of the present disclosure.

In block 510, a storage media device monitoring solution identifies a specific device (such as one of storage media devices 430) as one that may potentially fail. Although such a device has been identified, it may or may not be prone to imminent failure. That is, it may be a false positive indication. In the case of indicators that a given drive is likely to fail within a time period but operates much longer, wherein a potentially failing drive is not flagged for immediate removal, such drives may be scheduled for testing during such a time period to verify any potentially failing drives. The solution may be executing on, for example, for example, motherboard processor 220 accessing trays 400 through interfaces 240, 340.

In block 512, an SDS application executing on, for example, motherboard processor 220 may remove (via software, as opposed to physical removal) the potentially failing storage media device 430 from the production environment wherein storage media device 430 is used for SDS. The first step may be to remove the object storage software of failing storage media device 430 from the cluster of storage media devices that are in use by the SDS application. This may include, once the SDS application has acknowledged that a storage media is to be removed from the usage of the SDS application, the SDS application re-balancing the cluster of storage media devices 430 and copying the data from the storage media device that is to be removed from the usage of the SDS application. The status of the instance of storage media device 430 that is being removed can be monitored. The SDS application may signal when a state has been reached where all of the data has been copied from the storage media device 430 that is to be removed. Once this state has been reached, the object storage software for the storage media device 430 to be removed can be stopped and removed.

In block 514, motherboard processor 220, executing the SDS application, may notify BMC processor 120 of the potentially failing storage media device 430 using shared memory 210 and serial communication channel 140. This may also include identifying the tray 400 in which the potentially failed media device is housed.

In block 516, BMC processor 120 may disconnect or cause the disconnection of the potentially failing storage media device 430 from production data interface 340. BMC processor 120 may, using serial communication channel 140, instruct programmable differential amplifiers 330 to turn off the connection through interface 340 to the potentially failing device. BMC processor 120 may, using serial communication channel 140, 350, instruct the corresponding media tray manager 410 to disconnect the potentially failing storage media device 430 from production data interface 340 using interface selector 420. This may completely isolate the potentially failing storage media device 430 from the production environment of the SDS system operating on motherboard 200. This may allow testing to be conducted outside of the production environment. BMC processor 120 may inform motherboard processor 220 using shared memory 320 that the potentially failing storage media device 430 has been isolated. Further communication between elements executing on motherboard processor 220 and the isolated device 430 may be prevented. Communication and testing may be performed instead through the OOB channel through interface 360.

At block 518, motherboard processor 220 may respond to the isolation of the potentially failing storage media device 430 by reflecting the new state of the device using external visual indicators 230 using, for example, a specific error code. This may allow an external observer, such as a data center technician, to know that the potentially failing storage media device 430 has been isolated and is scheduled for testing in situ.

At block 520, media tray processor 440 may reflect the new status of the potentially failing storage media device 430 using the associated external intelligent media tray visual indicators 460. One external visual indicator, such as indicator 462, may be designed to signal if tray 400 should be removed from the server. At this point, indicator 462 may be set to signal that the tray 400 not be removed. For example, indicator 462 may be turned off. A second visual external indicator, such as indicator 464, may be designed to signal that a potentially failing storage media device has been isolated from the production environment and is scheduled for testing. For example, indicator 464 may be turned blue.

At block 522, media tray processor 440 may reflect the new status of the potentially failing device using the associated internal intelligent media tray visual indicators 460. The specific internal visual indicator 466 associated with the failing storage media device 430 may identify the potentially failing storage media device 430 that has been isolated from the production environment and is scheduled for testing. For example, such an indicator 466 may turn blue.

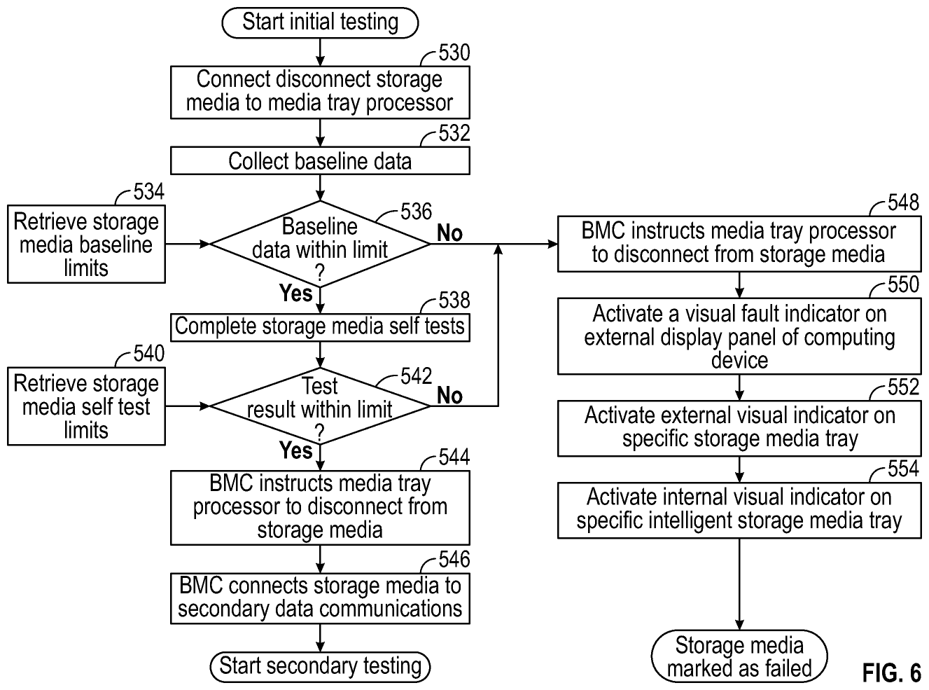

At block 524, BMC processor 120 may instruct the respective media tray manager 410 to start a self-testing sequence for the potentially failing storage media device 430. This may be performed for example, the method of FIG. 6.

FIG. 6 is an illustration of an example method for self-testing of a potentially failing storage media device, according to embodiments of the present disclosure. The method may be performed fully or in part by the control circuit as described above.

At block 530, BMC processor 120 may, using serial communication channel 140, 350, instruct media tray manager 410, using interface selector 420, to connect the potential failing storage media device 430 to media tray processor 440. Media tray processor 440 may be configured to perform operations in any suitable manner, such as configuration and use of media tray manager 410.

At block 532, media tray manager 410 may collect baseline data of the operation of the potential failing storage media device 430. This may include the operational data that was collected during production operations, during which it was determined that storage media device 430 was potentially failing. This information may include additional information that was not used to determine the potential that the storage media may fail. Such information may include throughput performance, drive start and stop times, unexpected power loss and spin high current.

At block 534, media tray manager 410 may receive or retrieve storage media baseline limits. These limits may be retrieved from BMC processor 120 or any suitable memory. The limits may be specific to a particular make or model of storage media device 430.

At block 536, media tray manager 410 may compare the measured baseline data obtained in block 532 from production operations against the baseline limits obtained in block 534. If the baseline data is within the limits, the method may proceed to block 538. Otherwise, the method may proceed to block 548. The baseline limits applied in block 536 may be of a same or different metric than metrics made to determine that a given storage media device 430 is potentially failing as determined in block 510. For example, in block 510, a one percent failure rate of operating system-based reads and writes for a given storage media device 430 may be sufficient to begin additional remediation efforts, but not large enough to immediately physically remove the given storage media device 430, and so the remainder of the method may be performed. In block 536, a failure rate limit of 2% may be applied, wherein if the given storage media device 430 exceeds such a failure rate of reads and writes, the method may proceed to block 548. However, other metrics may be used for baseline limits obtained in block 534 and compared against baseline data obtained in block 532, such as latency, throughput, or data corruption. The baseline data may be from the perspective of, for example, system-level or production system operations.

At block 538, media tray manager 410 may utilize any available self-test utilities provided by the potentially failing storage media device 430. For example, such tests may include Self-Monitoring, Analysis and Reporting Technology, S.M.A.R.T, self-tests. The self-tests may be defined by a maker of storage media device 430 and specific to a make or model of device 430. Since these tests may vary by device type, BMC processor 120 may instruct media tray manager 410 about which tests to execute, or to instruct storage media device 430 to conduct. These self-tests may be performed internal to the potentially failing storage media device 430. These tests may determine information that was unavailable in evaluating the status of storage media devices 430 in the evaluations of, for example, blocks 510, 536. However, these self-tests might not detect problems with the interface circuit to storage media device 430, as the test is internal to storage media device 430.

At block 540, media tray manager 410 may retrieve storage media test limits. These limits may be provided by BMC processor 120 or stored in any suitable memory, and may be specific to the make or model or type of storage media device 430. These test limits may relate to self-tests to be performed in block 542.

At block 542, media tray manager 410 may compare the results from self-tests from block 538 against the storage media test limits from block 540. If the self-test data is within limits, then the method may proceed to block 544. Otherwise, the method may proceed to block 548. If the self-test is within the limits, then a possible false positive with respect to the original determination in block 510 may have occurred, and further steps of the method may further evaluate possibility of the failure of the given storage media device 430. If the self-test is not within the limits, this may represent an actual failure supporting the original diagnosis of block 510.

At block 544, BMC processor 120 may instruct media tray manager 410 to control interface selector 420 to disconnect the potential failing storage media device 430 from media tray processor 440.

At block 546, BMC processor 120 may connect the potentially failing storage media device 430 to secondary data interface 360. BMC processor 120 may, using serial communication channel 140, instruct programmable differential amplifiers 330 to turn on the connection from secondary data interface 360 to the instance of the potentially failing storage media device 430. BMC processor 120 may, using serial communication channel 140, 340 instruct the corresponding media tray manager 410 to connect the potentially failing storage media device 430 to secondary data interface 360 using interface selector 420. This may allow BMC processor 120 to directly control or interface with the potentially failing storage media device 430, without going through the SDS application operated by motherboard 200. This may provide interactions free from any errors that may have occurred in, for example, motherboard processor 220, programmable differential amplifiers 330, interfaces 240, 340, or between these elements and the potentially failing storage media device 430.

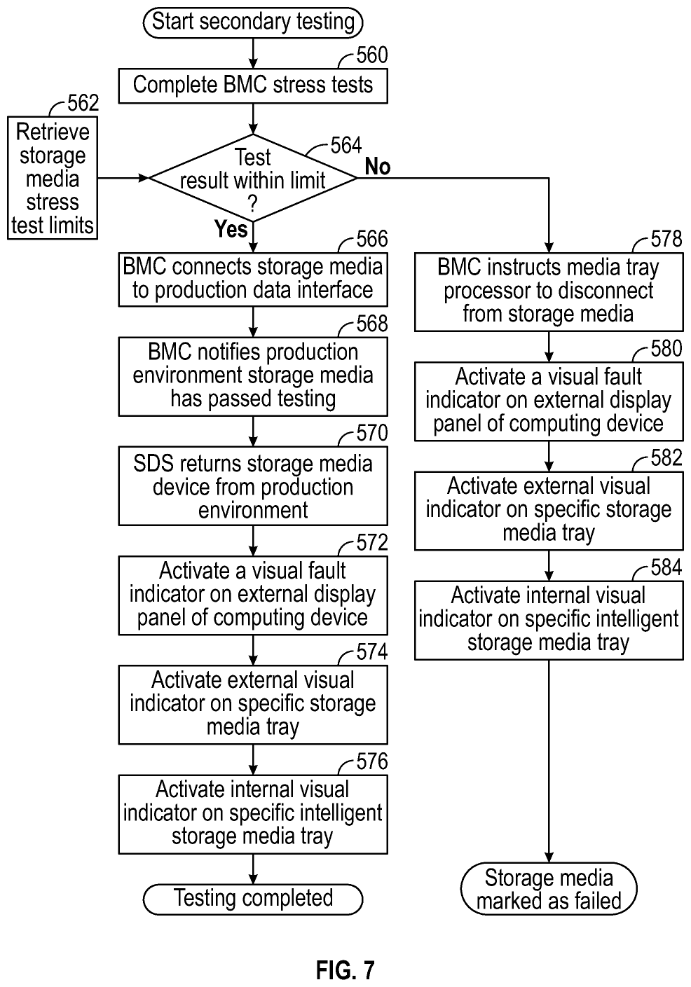

The method of FIG. 7 might be executed next to perform secondary testing, after execution of block 546.

In block 548, BMC processor 120 may disconnect the potentially failing storage media device 430 from media tray processor 440. This may completely isolate the potentially failing storage media device 430 from the production environment of the SDS application of motherboard 200. This may allow the potentially failing storage media device 430 to be replaced. BMC processor 120 may inform motherboard processor 220, using shared memory 320, that the potentially failing storage media device 430 has been isolated and requires replacement.

At block 550, motherboard processor 220 may respond to the isolation of the potentially failing storage media device 430 by reflecting the new state of the storage media device 430 using external visual indicators 230. This may allow an external observer, such as a data center technician, to know that the potentially failing storage media device 430 has been isolated and is scheduled for replacement.

At block 552, media tray processor 440 may reflect the new status of the potentially failing storage media device 430 using the associated external intelligent media tray visual indicators 460. Indicator 462 may signal whether tray 400 should be removed from the server. At this point, indicator 462 may be set to signal that tray 400 can be removed. Indicator 464 may signal that the potentially failing storage media device 430 has been isolated from the production environment and is scheduled for replacement.

At block 554, media tray processor 440 may reflect the new status of the potentially failing storage media device 430 using the associated internal visual indicator 466 that specifically identifies the potentially failing storage media device 430 that has been isolated from the production environment of the SDS application of motherboard 200 and is scheduled for replacement.

FIG. 7 is an illustration of an example method for secondary or stress testing of a potentially failing storage media device, according to embodiments of the present disclosure.

In block 560, BMC processor 120 may directly connect to the potentially failed storage media device 430 to conduct stress tests. This may be performed by connecting through interfaces 130, 150, pass-through motherboard 200 if necessary, to programmable differential amplifiers 330 and subsequently through interface 360 and selected by interface selector 420 to be applied to the potentially failed storage media device 430. This may have an advantage in that external testing—through BMC processor 120 without use of the SDS production environment—can be performed on the potentially failed storage media device 430 directly without incurring any errors introduced by the SDS production environment or interfaces (such as interface 340) to the potentially failed storage media device 430, and without physically removing the potentially failed storage media device 430. These tests may create a greater performance demand on storage media device 430 as compared to the tests of blocks 510, 536, 542. This may require additional computing power and data sources for the tests as compared to the tests of blocks 510, 536, 542. The test data may be read or generated as required by BMC processor 120 using any suitable algorithms, such as by a random number generator. This may enable BMC processor 120 to send random data to random, or sequential, locations on the potentially failed storage media device 430. Since these tests may take a long time, such as several hours, the use of BMC processor 120 may isolate production resources from impact, as the test of storage media device 430 is being performed while removed from production resources of the SDS application. Any suitable types of tests may be used. The type of tests or the data used may be commensurate to the device type, make, or model. In other solutions, such testing may require the potentially failed storage media device 430 to be physically removed from tray 400 and the rest of the system to be tested. Further, the secondary tests of block 560 may be destructive tests, wherein the original data might not be retained. In embodiments of the present disclosure, because the tests are performed on storage media devices 430 that are used within the context of an SDS application with redundancy, the original data is preserved elsewhere and can be restored later if required. The stress tests of block 564 may be able to provide testing unavailable by tests in blocks 510, 536, 542. Such other blocks might not have sufficient connectivity or processor power in view of the SDS application, or may otherwise require physically removing the potentially failing storage media device 430 in order to provide stress tests. BMC processor 120 may collect the results of the stress tests.

In block 562, BMC processor 120 may retrieve any stress test limits for the particular type, make, or model of the potentially failed storage media device 430. These may be stored in any suitable manner.

In block 564, BMC processor 120 may compare the stress test results from block 560 against the limits retrieved in block 562. If the stress tests are within these limits, then the method may proceed to block 566 as the storage media device 430 may be deemed fit for further production use. Otherwise, the method may proceed to block 578 and the storage media device 430 may be scheduled for physical replacement.

In block 566, BMC processor 120 may reconnect the formerly potentially failing storage media device 430 to production data interface 340. BMC processor 120 may, using serial communication channel 140, instruct programmable differential amplifiers 330 to activate the connection to the formerly potentially failing storage media device 430. BMC processor 120 may, using serial communication channel 140, 350, instruct the corresponding media tray manager 410 to connect to production data interface 340 using interface selector 420. This may completely reintegrate the formerly potentially failing storage media device 430 into the production environment of the SDS application of motherboard 200. BMC processor 120 may instruct programmable differential amplifiers 330 to disable secondary communications interface 360 as to the formerly potentially failing storage media device 430. This may save power consumption and reduce any interference with the production environment that could bias the storage device failure prediction application.

In block 570, BMC processor 120 may use shared memory 210 to alert motherboard processor 220 that the formerly potentially failing storage media device 430 has passed the secondary testing phase. Further, motherboard processor 220 may use the SDS application to return the storage media device 430 to the production environment and may replace any original data lost in the stress testing.

At block 572, motherboard processor 220 may respond to the reintegration of the formerly potentially failing storage media device 430 by reflecting the new state of storage media device 430 using external visual indicators 230. This may allow an external observer, such as a data center technician, to know that the formerly potentially failing storage media device 430 has passed testing and been integrated into the production environment.

At block 574, media tray processor 440 may reflect the new status of the potentially failing device using the associated external intelligent media tray visual indicators 460. Indicator 462, designed to signal whether tray 400 should be removed from the server, may be set to signal that the intelligent tray need not be removed. Indicator 464 may indicate that a potentially failing storage media device has passed testing and been integrated into the production environment.

At block 576, media tray processor 440 may reflect the new status of the potentially failing device using the associated internal intelligent media tray visual indicators 460. A specific one of indicators 466 may identify that the formerly potentially failing storage media device 430 is operational.

The method may complete as testing has ended.

In block 578, BMC processor 120 may instruct programmable differential amplifiers 330 to disable secondary communications interface 360 from the failed storage media device 430. This may save power consumption and reduce any interference with the production environment that could bias the storage device failure prediction application. This may allow the failing storage media device 430 to be replaced. BMC processor 120 may inform motherboard processor 220, using shared memory 320, that the failing storage media device 430 has been isolated and requires replacement.

At block 580, motherboard processor 220 may respond to the isolation of the potentially failing storage media device 430 by reflecting the new state of the storage media device 430 using external visual indicators 230. This may allow an external observer, such as a data center technician, to know that the potentially failing storage media device 430 has been isolated and is scheduled for replacement.

At block 582, media tray processor 440 may reflect the new status of the potentially failing storage media device 430 using the associated external intelligent media tray visual indicators 460. Indicator 462 may signal whether tray 400 should be removed from the server. At this point, indicator 462 may be set to signal that tray 400 can be removed. Indicator 464 may signal that the potentially failing storage media device 430 has been isolated from the production environment and is scheduled for replacement.

At block 584, media tray processor 440 may reflect the new status of the potentially failing storage media device 430 using the associated internal visual indicator 466 that specifically identifies the potentially failing storage media device 430 that has been isolated from the production environment of the SDS application of motherboard 200 and is scheduled for replacement. The method may complete.

Embodiments of the present disclosure may include an apparatus. The apparatus may include a processor interface circuit. The processor interface circuit may be implemented in any suitable manner, such as by channels, wires, traces, analog circuitry, digital circuitry, control logic, instructions for execution by a processor, digital logic circuits programmed through hardware description language, ASICs, FPGAs, PLDs, or any suitable combination thereof. The processor interface circuit may be from the apparatus to a motherboard processor. The motherboard processor may be configured to execute software to access a media tray. The access may be through an in-band interface or connection. The media tray may accept or hold any suitable number and kind of storage devices. The motherboard processor may access the storage devices on the media tray through a data interface circuit. The data interface circuit may be implemented in any suitable manner, such as by channels, wires, traces, analog circuitry, digital circuitry, control logic, instructions for execution by a processor, digital logic circuits programmed through hardware description language, ASICs, FPGAs, PLDs, or any suitable combination thereof. The apparatus may include an OOB interface circuit implemented in any suitable manner, such as by channels, wires, traces, analog circuitry, digital circuitry, control logic, instructions for execution by a processor, digital logic circuits programmed through hardware description language, ASICs, FPGAs, PLDs, or any suitable combination thereof. The OOB interface circuit may be configured to connect the apparatus to the media tray. The OOB interface circuit may be separate from the data interface circuit and the processor interface circuit. The apparatus may include circuitry configured to determine a preliminary indication that a candidate storage device of the storage devices will fail, cause isolation of the candidate storage device from the motherboard processor based upon the determination of the preliminary indication, and run a secondary diagnostic test on the candidate storage device through the OOB interface after isolating the candidate storage device.

The apparatus may be located on a BMC. The configuration of the apparatus may be performed by a BMC processor. The BMC may connect to the tray over any suitable format or protocol, such as a serial interface. The OOB connection may be made over any suitable format or protocol. The OOB connection may be routed through the motherboard in a pass-through manner or routed outside of the motherboard. The apparatus and the motherboard processor may communicate through any suitable exchange of data or signals, such as values written to a shared memory. The shared memory may be on the motherboard. The BMC may connect to the tray through a baseboard. The OOB connection may be made through the baseboard. The OOB connection may be made through programmable differential amplifiers on the baseboard. The motherboard processor may also be connected to the media tray through the amplifiers. The amplifiers may be programmed by the apparatus through any suitable protocol or mechanism, such as by shared memory. A multi-channel interface of any suitable protocol or mechanism may be provided between the amplifiers and the media tray. The media tray may include a processor and an interface selector. The interface selector may be configured to select between the multi-channel interface to the motherboard processor and the OOB interface to the apparatus to apply the selected interface to a given storage device in the tray.

In combination with any of the above embodiments, the circuitry may be further configured to, based on the preliminary indication that the candidate storage device will fail, set a visual indicator that the candidate storage device may fail.

In combination with any of the above embodiments, the circuitry may be further configured to, based on the preliminary indication that the candidate storage device will fail, set a visual indicator that the candidate storage is under diagnostic test.

In combination with any of the above embodiments, the circuitry may be further configured to, based on the preliminary indication that the candidate storage device will fail, set a visual indicator.

In combination with any of the above embodiments, the preliminary indication may be the result of a previous diagnostic test of the candidate storage device through use of the motherboard processor.

In combination with any of the above embodiments, the secondary diagnostic test may be performed without at least one interface used to access the candidate storage device in the previous diagnostic test.

In combination with any of the above embodiments, the circuitry may be further configured to, based on an end of the secondary diagnostic test, disable the OOB interface.

In combination with any of the above embodiments, the circuitry may be further configured to, to cause isolation of the candidate storage device from the motherboard processor based upon the determination of the preliminary indication, disable access between the candidate storage device and the motherboard processor through the data interface circuit.

In combination with any of the above embodiments, the circuitry may be further configured to cause isolation of the candidate storage device from the motherboard processor based upon the determination of the preliminary indication through adjustment of programmable differential amplifiers configured to access the plurality of storage devices.

In combination with any of the above embodiments, the adjustment of programmable differential amplifiers may include turning off an output going to the candidate storage device.

In combination with any of the above embodiments, the circuitry may be further configured to perform the secondary diagnostic test simultaneously with access by a software defined system (SDS) of the plurality of storage devices and prevention of access by the SDS of the candidate storage device.

Although example embodiments have been described above, other variations and embodiments may be made from this disclosure without departing from the spirit and scope of these embodiments.

We claim:

1. An apparatus, comprising:
a processor interface circuit to a motherboard processor, the motherboard processor to execute software to access a media tray, the media tray to accept a plurality of storage devices, the motherboard processor to access the storage devices on the media tray through a data interface circuit;
an out of band (OOB) interface circuit to connect the apparatus to the media tray, the OOB interface circuit separate from the data interface circuit and the processor interface circuit;
circuitry configured to:
determine a preliminary indication that a candidate storage device of the plurality of storage devices will fail;
cause isolation of the candidate storage device from the motherboard processor based upon the determination of the preliminary indication; and
run a secondary diagnostic test on the candidate storage device through the OOB interface after isolating the candidate storage device.

2. The apparatus of claim 1, wherein the circuitry is further configured to, based on the preliminary indication that the candidate storage device will fail, set a visual indicator that the candidate storage device may fail.

3. The apparatus of claim 1, wherein the circuitry is further configured to, based on the preliminary indication that the candidate storage device will fail, set a visual indicator that the candidate storage is under diagnostic test.

4. The apparatus of claim 1, wherein the circuitry is further configured to, based on the preliminary indication that the candidate storage device will fail, set a visual indicator.

5. The apparatus of claim 1, wherein the preliminary indication is the result of a previous diagnostic test of the candidate storage device through use of the motherboard processor.

6. The apparatus of claim 5, wherein the secondary diagnostic test is performed without at least one interface used to access the candidate storage device in the previous diagnostic test.

7. The apparatus of claim 1, wherein the circuitry is further configured to, based on an end of the secondary diagnostic test, disable the OOB interface.

8. The apparatus of claim 1, wherein the circuitry is further configured to, to cause isolation of the candidate storage device from the motherboard processor based upon the determination of the preliminary indication, disable access between the candidate storage device and the motherboard processor through the data interface circuit.

9. The apparatus of claim 1, wherein the circuitry is further configured to cause isolation of the candidate storage device from the motherboard processor based upon the determination of the preliminary indication through adjustment of programmable differential amplifiers configured to access the plurality of storage devices.

10. The apparatus of claim 9, wherein the adjustment of programmable differential amplifiers includes turning off an output going to the candidate storage device.

11. The apparatus of claim 1, wherein the circuitry is further configured to perform the secondary diagnostic test simultaneously with access by a software defined system (SDS) of the plurality of storage devices and prevention of access by the SDS of the candidate storage device.

12. A method, comprising, from an apparatus:
accessing a motherboard through a processor interface circuit, the motherboard to include a motherboard processor, the motherboard processor to execute software to access a media tray, the media tray to accept a plurality of storage devices, the motherboard processor to access the storage devices on the media tray through a data interface circuit;
connecting to the media tray through an out of band (OOB) interface circuit, the OOB interface circuit separate from the data interface circuit and the processor interface circuit;
determining a preliminary indication that a candidate storage device of the plurality of storage device will fail;
causing isolation of the candidate storage device from the motherboard processor based upon the determination of the preliminary indication; and
running a secondary diagnostic test on the candidate storage device through the OOB interface after isolating the candidate storage device.

13. The method of claim 12, further comprising, based on the preliminary indication that the candidate storage device will fail, setting a visual indicator that the candidate storage device may fail.

14. The method of claim 12, further comprising, based on the preliminary indication that the candidate storage device will fail, setting a visual indicator that the candidate storage is under diagnostic test.

15. The method of claim 12, further comprising, based on the preliminary indication that the candidate storage device will fail, set a visual indicator.

16. The method of claim 12, wherein the preliminary indication is the result of a previous diagnostic test of the candidate storage device through use of the motherboard processor.

17. The method of claim 16, further comprising performing the secondary diagnostic test without at least one interface used to access the candidate storage device in the previous diagnostic test.

18. The method of claim 12, further comprising, based on an end of the secondary diagnostic test, disabling the OOB interface.

19. The method of claim 12, further comprising, to cause isolation of the candidate storage device from the motherboard processor based upon the determination of the preliminary indication, disabling access between the candidate storage device and the motherboard processor through the data interface circuit.

20. The method of claim 12, further comprising causing isolation of the candidate storage device from the motherboard processor based upon the determination of the preliminary indication through adjustment of programmable differential amplifiers configured to access the plurality of storage devices.

21. The method of claim 20, wherein the adjustment of programmable differential amplifiers includes turning off an output going to the candidate storage device.

22. The method of claim 12, further comprising performing the secondary diagnostic test simultaneously with access by a software defined system (SDS) of the plurality of storage devices and prevention of access by the SDS of the candidate storage device.
